(19) United States
(12) Patent Application Publication
(10) Pub. No.: US 2012/0321374 A1
(43) Pub. Date: Dec. 20, 2012

(54) UNIVERSAL JOINT WITH A POSITIONING STRUCTURE

(76) Inventor: Hwang Ray, Taichung (TW)

(21) Appl. No.: 13/329,264

(22) Filed: Dec. 17, 2011

(30) Foreign Application Priority Data
Jun. 17, 2011 (TW) 100121255

(51) Int. Cl. F16C 11/06

(52) U.S. Cl. 403/111

(57) ABSTRACT

A universal joint with a positioning structure contains: a base including a fitting segment disposed on one end thereof and a receiving groove fixed on another end thereof; a tool set including a driving segment formed on one end thereof and a knob mounted on another end thereof; between the receiving groove and the knob being defined an engaging structure; wherein the base includes a fixing structure, the fixing structure includes at least one pressing member fixed on a wall thereof and a sliding sleeve fitted on an outer peripheral surface thereof, the sliding sleeve includes an abutting face and a chamber to control the pressing member to press the knob, the base also includes at least one connecting segment disposed on the outer peripheral surface thereof, the sliding sleeve includes at least one coupling segment fixed on the inner surface thereof to engage with the connecting segment.

### BACKGROUND OF THE INVENTION

1. Field of the Invention

The present invention relates to a sliding sleeve to position so that the sliding sleeve control a pressing member to press a tool set, such that the tool set is positioned securely to prevent from disengagement, thus enhancing operational safety of a universal joint with a positioning structure.

2. Description of the Prior Art

A conventional universal joint can match with a driving tool (such as a hand tool or a pneumatic tool) to dissemble bolt. To match with different types and sizes of bolts, a base of the conventional universal joint can cooperate with different types and sizes of tool sets. Referring to FIG. 1, a knob structure of a conventional socket disclosed in TW Pat. No. M 399780 includes a base 11 having a square hole 111 disposed on one end of the base 11 to match with a wrench tool and a non-circular orifice 112 fixed on another end of the base 11, the base 11 also includes a stopper 12 mounted on a wall thereof and extending out of the orifice 112, two resilient retainers 13, 14, and a controlling member 15. The controlling member 15 includes a pressing face 151 secured on an inner surface thereof to push the stopper 12 to move, an annular face 152 arranged over the pressing face 151, and a groove 153 formed below the pressing face 151, between the annular face 152 and the resilient retainer 13 is defined an elastic element 16 to push the controlling member 15 to displace downward so that the groove 153 of the controlling member 15 abuts against and limit the resilient element 14, an actuating member 17 includes a driving segment 171 and a polygonal adjusting segment 172, both of which are fixed on two ends thereof respectively, wherein the adjusting segment 172 is inserted in the orifice 112 of the base 11, and when the pressing face 151 of the controlling member 15 pushes the stopper 12 to abut against the adjusting segment 172 of the actuating member 17, the adjusting segment 172 is locked in the orifice 112 of the base 11 so that the adjusting segment 172 of the actuating member 17 is adjusted at any angle, and the driving segment 171 is used to disassemble the bolt. As shown in FIG. 2, as desiring to replace the actuating member 17, the controlling member 15 is pushed upward so that the elastic element 16 is pressed by the annular face 152, and the groove 153 aligns with the stopper 12 to provide a space to the stopper 12 which returns. When removing the actuating member 17, the adjusting segment 172 of the actuating member 17 pushes the stopper 12 to displace into the groove 153 so that the stopper 12 releases the locking of the actuating member 17, disengaging the actuating member 17 from the base 11. However, there is no any fixing structure defined between the controlling member 15 and the base 11, only the elastic element pushes the controlling member 15 to move downward so that the pressing face 151 pushes the stopper 12 to abut against the adjusting segment 172 of the actuating member 17, such that the actuating member 17 is locked in the base 11. Therefore, as the controlling member 15 is impacted or vibrated to displace upward, the pressing face 151 leaves away from the stopper 12, and then the stopper 12 returns outward to release the locking of the actuating member 17, hence the actuating member 17 disengages from the base 11. Because the base 11 matches with the pneumatic tool to actuate the actuating member 17 to rotate at a high speed, when the base 11 disengages from the actuating member 17, an operational danger will occur.

The present invention has arisen to mitigate and/or obviate the afore-described disadvantages.

### SUMMARY OF THE INVENTION

The primary object of the present invention is to provide a universal joint with a positioning structure that is capable of prevent a tool set from disengagement to enhance operational safety.

Another object of the present invention is to provide a universal joint with a positioning structure that when a base cooperates with a pneumatic tool to disassemble a bolt, a connecting segment of the base engages with a coupling segment of a sliding sleeve to prevent the sliding sleeve from displacement because of vibration or collision so that an abutting face of the sliding sleeve pushes a pressing member to abut against a knob of the tool set to prevent the tool set from disengagement from the base, obtaining a safe operation.

To obtain the above objectives, a universal joint with a positioning structure provided by the present invention contains:

a base and a tool seat, the base including a fitting segment disposed on one end thereof and a receiving groove fixed on another end thereof, the tool set including a driving segment formed on one end thereof and a knob mounted on another end thereof and inserted into the receiving groove of the base, and between the receiving groove of the base and the knob of the tool set being defined an engaging structure; wherein the base includes a fixing structure secured thereon, and the fixing structure includes at least one pressing member fixed on a wall of the base and displacing horizontally and a sliding sleeve fitted on an outer peripheral surface of the base, the sliding sleeve includes an abutting face and a chamber to control the at least one pressing member to press the knob of the tool set, and the base also includes at least one connecting segment disposed on the outer peripheral surface thereof, the sliding sleeve includes at least one coupling segment fixed on the inner surface thereof to engage with the at least one connecting segment of the base.

### BRIEF DESCRIPTION OF THE DRAWINGS

FIG. 1 is a cross sectional view of a knob structure of a conventional socket disclosed in TW Pat. No. M399780;

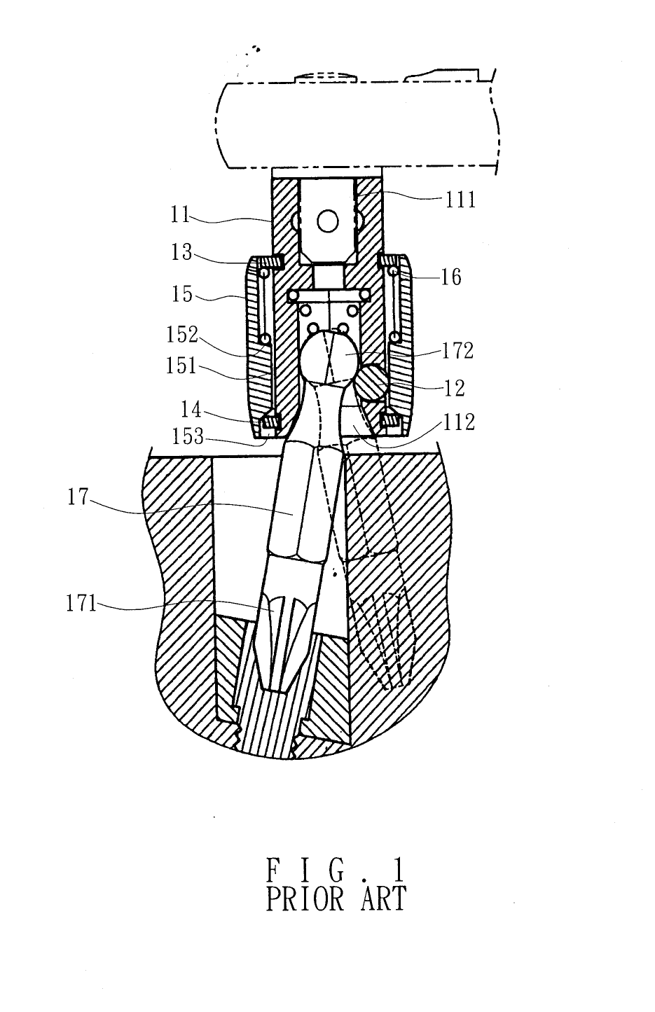

FIG. 2 is another cross sectional view of the knob structure of the conventional socket disclosed in TW Pat. No. M399780;

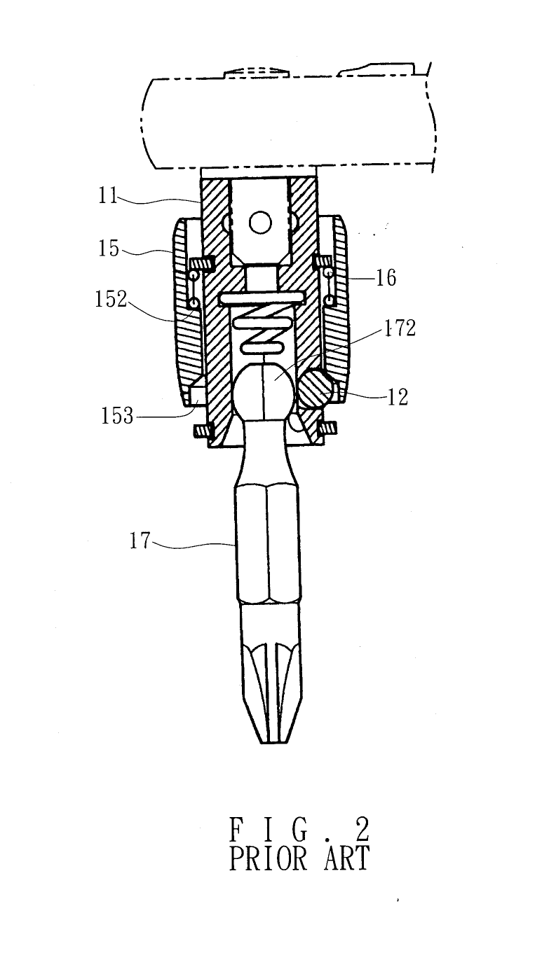

FIG. 3 is a perspective view showing the exploded components of a universal joint with a positioning structure according to a first embodiment of the present invention;

FIG. 4 is a perspective view showing the assembly of the universal joint with the positioning structure according to the first embodiment of the present invention;

FIG. 5 is a cross sectional view showing the assembly of the universal joint with the positioning structure according to the first embodiment of the present invention;

FIG. 6 is another cross sectional view showing the assembly of the universal joint with the positioning structure according to the first embodiment of the present invention;

FIG. 7 is a cross sectional view showing the operation of the universal joint with the positioning structure according to the first embodiment of the present invention;

FIG. 8 is another cross sectional view showing the operation of the universal joint with the positioning structure according to the first embodiment of the present invention;

FIG. 9 is also another cross sectional view showing the operation of the universal joint with the positioning structure according to the first embodiment of the present invention;

FIG. 10 is another cross sectional view showing the operation of the universal joint with the positioning structure according to the first embodiment of the present invention;

FIG. 11 is a perspective view showing the exploded components of a universal joint with a positioning structure according to a second embodiment of the present invention;

FIG. 12 is a perspective view showing the assembly of the universal joint with the positioning structure according to the second embodiment of the present invention;

FIG. 13 is a cross sectional view showing the assembly of the universal joint with the positioning structure according to the second embodiment of the present invention;

FIG. 14 is another cross sectional view showing the assembly of the universal joint with the positioning structure according to the second embodiment of the present invention;

FIG. 15 is a cross sectional view showing the operation of the universal joint with the positioning structure according to the second embodiment of the present invention;

FIG. 16 is another cross sectional view showing the operation of the universal joint with the positioning structure according to the second embodiment of the present invention;

FIG. 17 is also another cross sectional view showing the operation of the universal joint with the positioning structure according to the second embodiment of the present invention;

FIG. 18 is another cross sectional view showing the operation of the universal joint with the positioning structure according to the second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

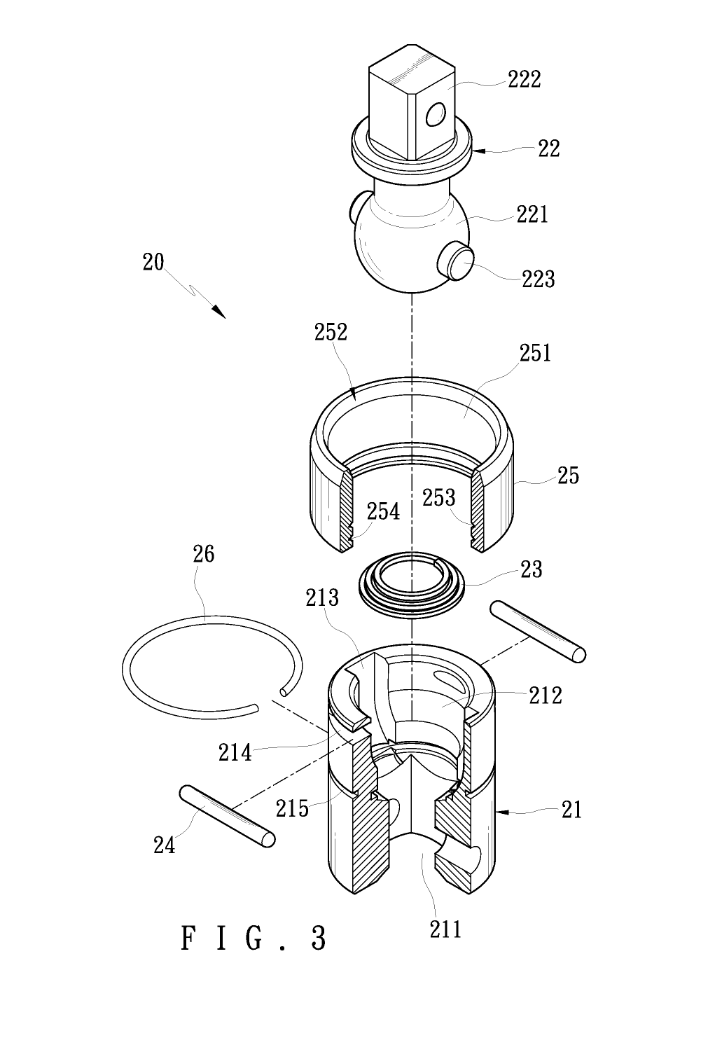

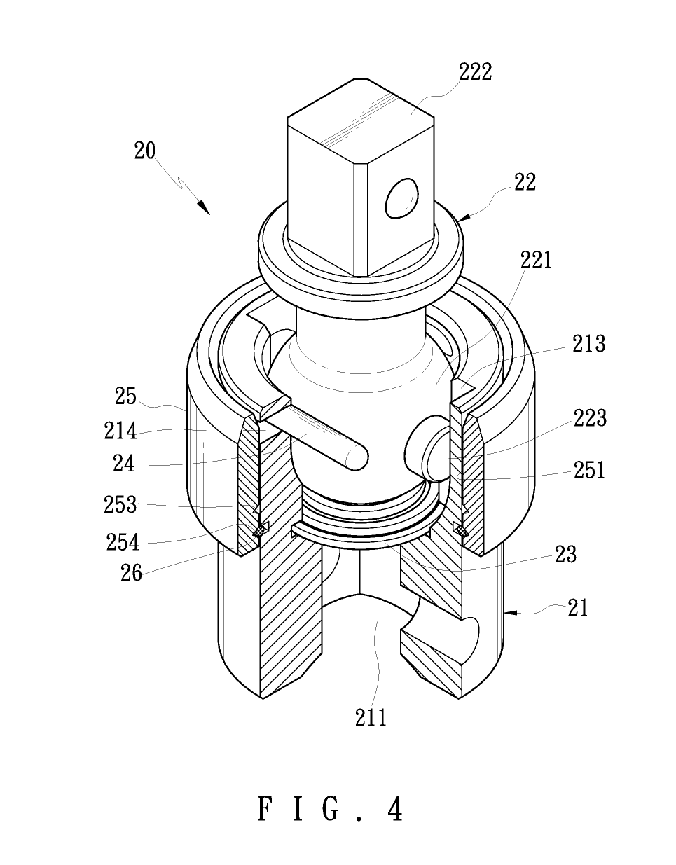

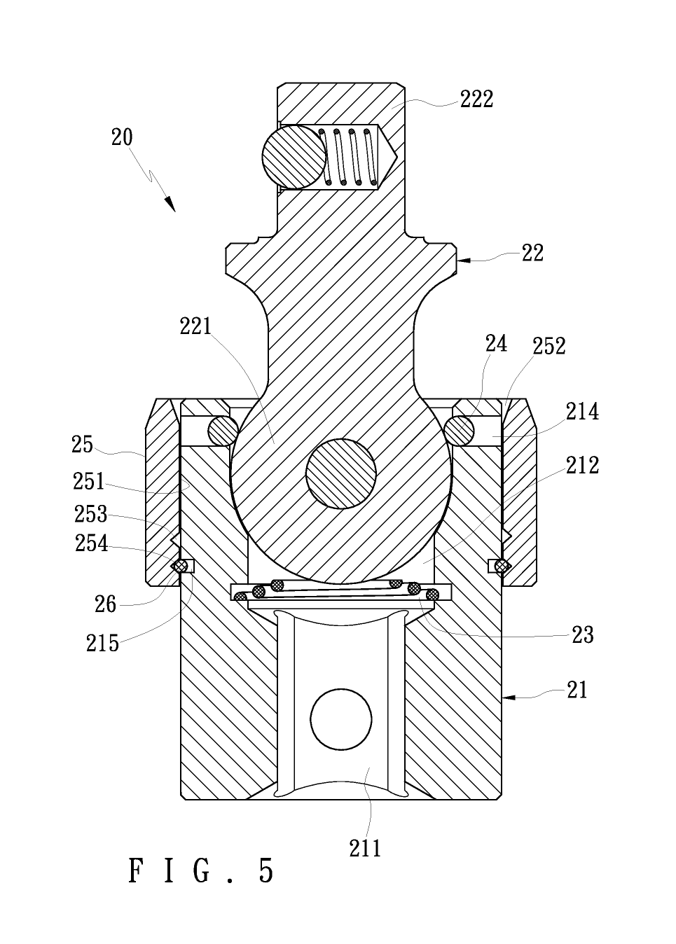

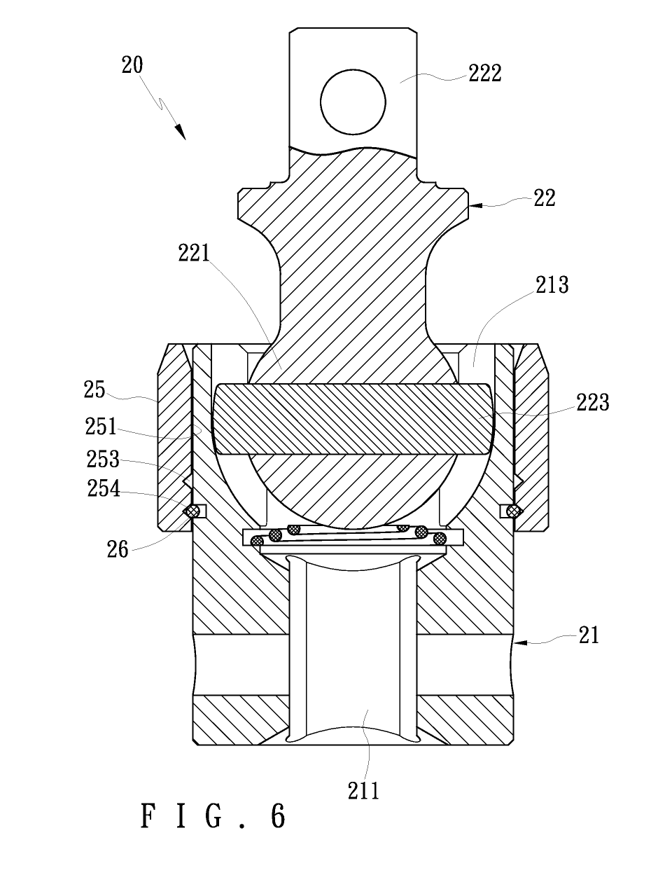

Referring to FIGS. 3-6, a universal joint 20 with a positioning structure according to a first embodiment of the present invention comprises a base 21 and a tool set 22, the base 21 includes a fitting segment 211 disposed on one end thereof and a receiving groove 212 fixed on another end thereof, and the fitting segment 211 is formed in a polygonal hole shape to fit a manual or a non-manual driving tool, such as a manual socket wrench, a power tool, and a pneumatic tool, and so on. In this embodiment, the fitting segment 211 of the base 21 is formed in a square hole shape, and a resilient element is fixed in the receiving groove 212, in this embodiment, the resilient element is a spring 23. The tool set 22 includes a knob 221 mounted on one end thereof and a driving segment 222 formed in different types and sizes, the knob 221 is circular or non-circular, and the driving segment 222 is used to fit with an operation tool, such as a socket, a screwdriver bit or a drill bit, and so on. In this embodiment, the driving segment 222 of the tool set 22 is formed in a square column shape, and between the receiving groove 212 of base 21 and the knob 221 of the tool set 22 is defined an engaging structure so that the base 21 actuates the tool set 22 to rotate simultaneously, the engaging structure includes a locking portion fixed on the receiving groove 212 of base 21 and a retaining portion fixed on the knob 221 of the tool set 22 to retain with the locking portion of the base 21, the locking portion is at least one locking recess fixed on an inner wall of the receiving groove of the base, and the retaining portion is at least one retaining block fixed on a circular knob of the tool set to retain with the at least one locking recess of the base so that the at least one locking recess of the base retains with the at least one retaining block of the tool set to rotate with the at least one retaining block. In addition, the locking portion of the engaging structure is a plurality of locking notches fixed on the inner wall of the receiving groove of base, and the retaining portion of the engaging structure is a number of retaining projections fixed on a non-circular knob of the tool set to retain with the plurality of locking notches respectively so that the plurality of locking notches of the base retain with the number of retaining projections of the tool set individually to rotate with the number of retaining projections together. In this embodiment, the locking portion of the engaging structure is two locking recesses 213 fixed on the inner wall of the receiving groove 212 of base 21, and the retaining portion of the engaging structure is two retaining blocks 223 fixed on the circular knob 221 of the tool set 22 so as to place the circular knob 221 of the tool set 22 in the receiving groove 212 of base 21, and the two retaining blocks 223 of the tool set 22 are retained in the two locking recesses 213 of the base 21 respectively so that the base 21 actuates the tool set 22 to rotate simultaneously. The base 21 also includes a fixing structure capable of controlling a replacement of the tool set 22, and the fixing structure includes at least one hole 214 arranged on a wall of the base 21 and communicating with the receiving groove 212 to receive a pressing member 24 which displaces horizontally, wherein the pressing member 24 is a rod or a ball. In this embodiment, the base 21 includes two holes 214 arranged on the wall thereof and communicating with the receiving groove 212 to receive a pressing member 24 which is a rod and displaces horizontally, wherein the pressing member 24 extends out of the receiving groove 212; the base 21 further includes a sliding sleeve 25 fitted on an outer peripheral surface thereof and displacing upward and downward thereon, the sliding sleeve 25 includes an abutting face 251 and a chamber 252, both of which are formed on an inner surface of the sliding sleeve 25 to control the pressing member 24 presses the knob 221 of the tool set 22. In this embodiment, the abutting face 251 is the inner surface of the sliding sleeve 25 to push the pressing member 24 to move inward, and the chamber 252 is fixed on a top end of the sliding sleeve 25 to provide a space to receive the pressing member 24 which returns outward, and the base 21 includes at least one connecting segment disposed on the outer peripheral surface thereof, the sliding sleeve 25 also includes a coupling segment fixed on the inner surface thereof to engage with the at least one connecting segment of the base 21 so as to position the sliding sleeve 25, wherein the connecting segment of the base 21 is a fixing element to displace resiliently and horizontally, and the fixing element is a C-shaped retainer or a ball, the coupling segment of the sliding sleeve 25 is a locating slot to engage with the fixing element of the base 21, the locating slot is formed in a loop shape or a non-loop shape. Besides, the connecting segment of the base 21 is a locating slot, and the locating slot is formed in a loop shape or a non-loop shape, the coupling segment of the sliding sleeve 25 is a fixing element to displace resiliently and horizontally and to engage with a locating slot of the base 21, and the fixing element is a C-shaped retainer or a ball. In this embodiment, the connecting segment of the base 21 includes a trough 215 secured on the outer peripheral surface thereof to receive the fixing element, and the fixing element is a C-shaped retainer 26 to expand and retract resiliently and horizontally, the coupling segment of the sliding sleeve 25 is a locating slot formed on the inner surface of the sliding sleeve 25, i.e., the sliding sleeve 25 includes a first locating slot 253 and a second locating slot 254, both of which are arranged on the inner surface of the sliding sleeve 25, when the second locating slot 254 of the sliding sleeve 25 engages with the C-shaped retainer 26 of the base 21, the abutting face 251 pushes the two pressing members 24 to move inward and horizontally to abut against the knob 221 of the tool set 22 so that the tool set 22 is positioned in the base 21, finishing the assembly of the universal joint 20.

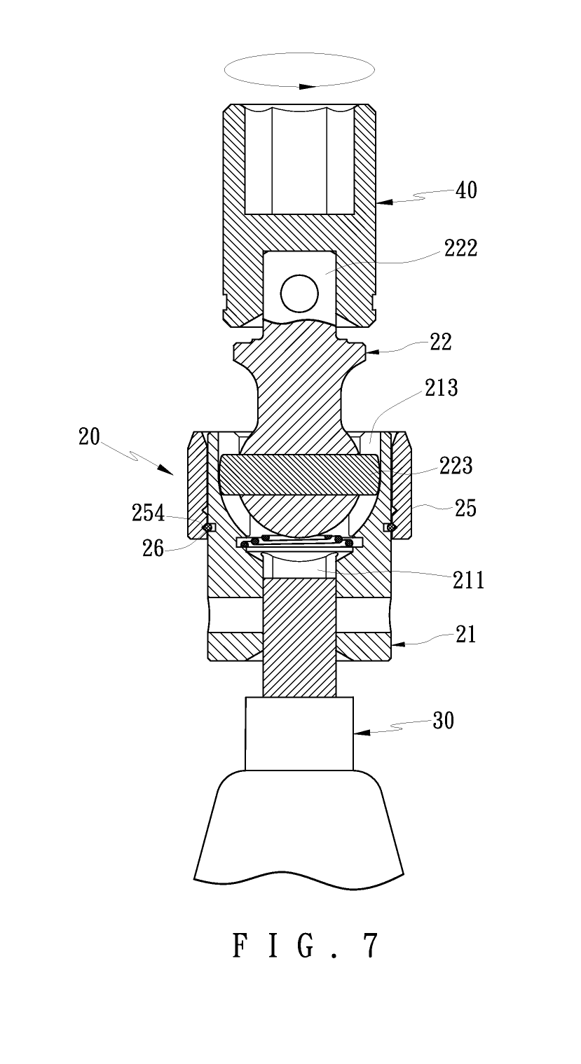

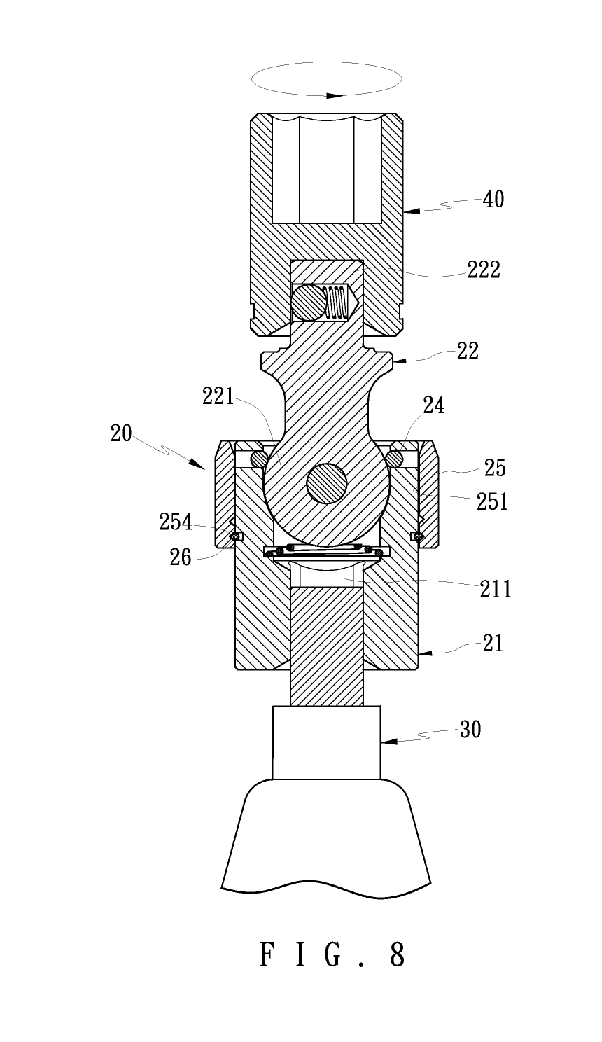

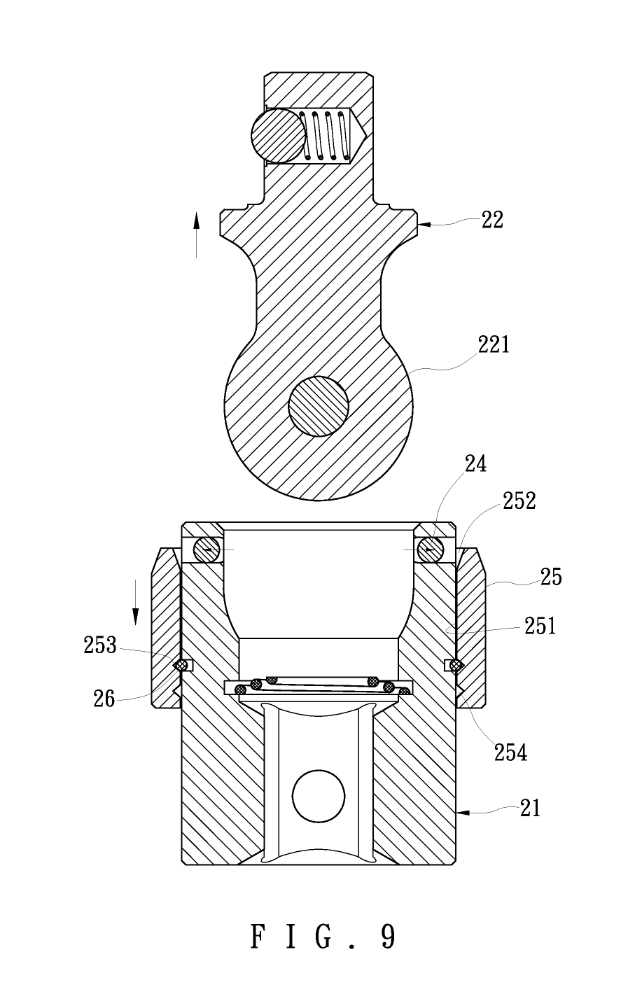

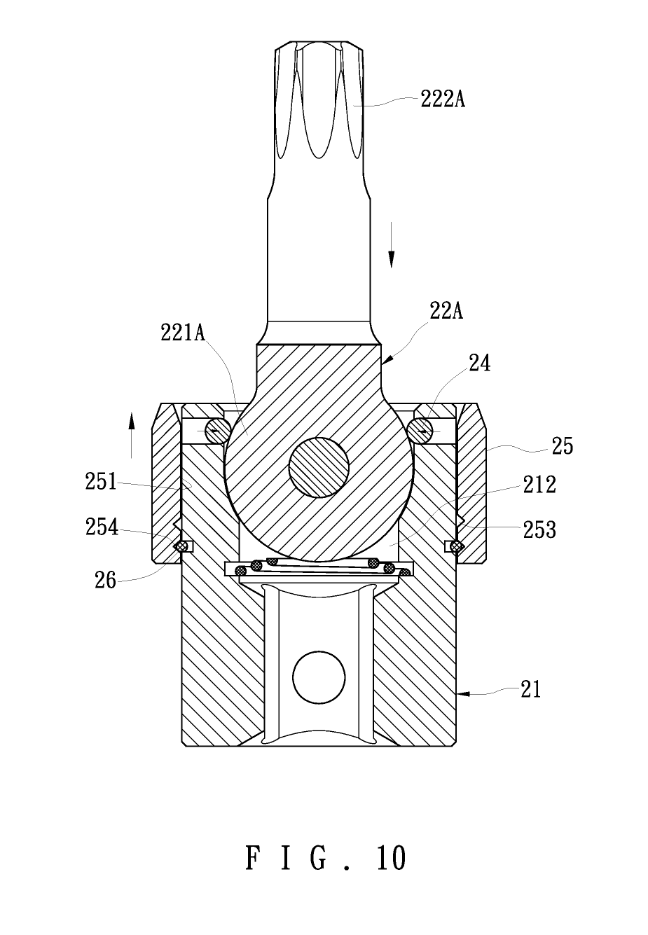

Referring to FIGS. 7 and 8, in operation of the universal joint 20, the fitting segment 21 of the base 21 is fitted with the pneumatic tool 30, and the driving segment 222 of the tool set 20 is fitted with the socket 40, because the C-shaped retainer 26 of the base 21 is engaged in the second locating slot 254 of the sliding sleeve 25, the sliding sleeve 25 is positioned in the base 21 securely to prevent from an upward and downward displacement because to vibration. Thereby, the abutting face 251 of the sliding sleeve 25 pushes the pressing member 24 to be biased against the knob 221 of the tool set 22 so that the tool set 22 is fixed on the base 21 fixedly. When the pneumatic tool 30 actuates the base 21 to rotate, the two locking recesses 213 retain with two retaining blocks 223 individually to actuate the tool set 22 to rotate simultaneously, obtaining a safe operation. As shown in FIG. 9, as desiring to replace the tool set 22 with different types of driving segments, the sliding sleeve 25 is pushed downward so that the second locating slot 254 of the sliding sleeve 25 disengages from the C-shaped retainer 26 of the base 21, and the abutting face 251 abuts against the C-shaped retainer 26 so that the C-shaped retainer 26 retracts inward. After the first locating slot 253 of the sliding sleeve 25 aligns with the C-shaped retainer 26, due to the C-shaped retainer 26 is not abutted any more and is engaged in the first locating slot 253 to position the sliding sleeve 25, the chamber 252 of the sliding sleeve 25 aligns with the pressing member 24 to allow the pressing member 24 to return therein, and when the tool set 22 is removed, the knob 221 pushes the pressing member 24 outward to move into the chamber 252 of the sliding sleeve 25 so as to further disengage from the knob 221, disengaging the tool set 22 from the base 21 to replace another tool set. As illustrated in FIG. 10, as positioning another tool set 22A with another driving segment 222A (such as a screwdriver bit), a knob 221A of the tool set 22A is fixed in the receiving groove 212 of the base 21, and the sliding sleeve 25 is moved upward so that the first locating slot 253 of the sliding sleeve 25 disengages from the C-shaped retainer 26 of the base 21, and the abutting face 251 presses the C-shaped retainer 26 to move inward. After the second locating slot 254 of the sliding sleeve 25 aligns with the C-shaped retainer 26, the C-shaped retainer 26 expends outward to retain in the second locating slot 254 so that the sliding sleeve 25 is fixed besides the base 21 to prevent from an upward and downward displacement because of vibration. Thereby, the abutting face 251 of the sliding sleeve 25 presses the pressing member 24 to abut against the knob 221A of the tool set 22A so that the tool set 22A is fixed on the base 21 securely, thus replacing different tool sets.

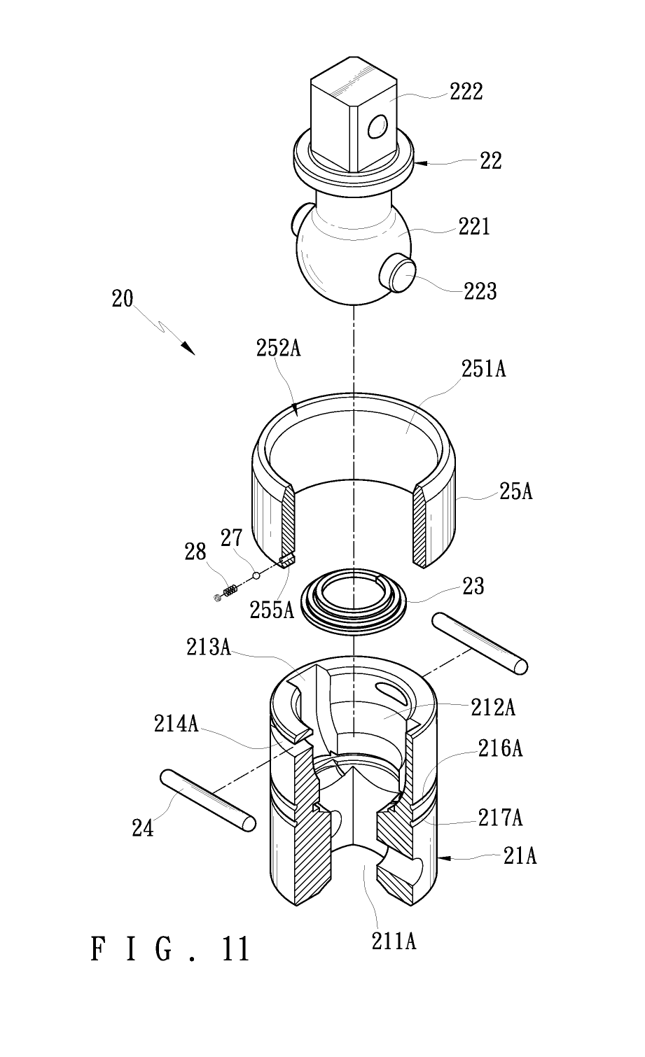

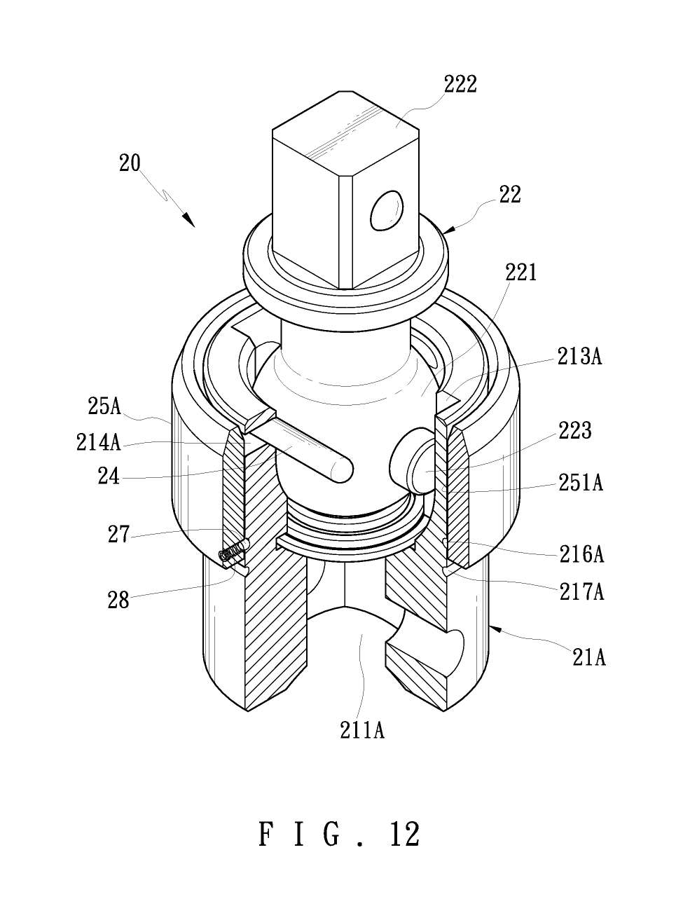

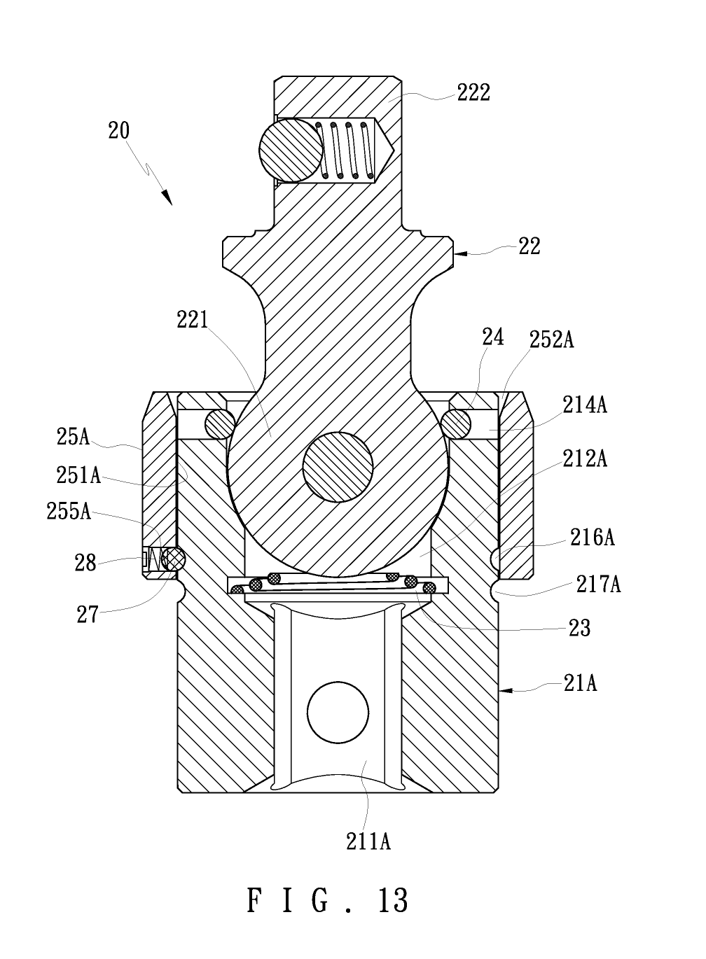

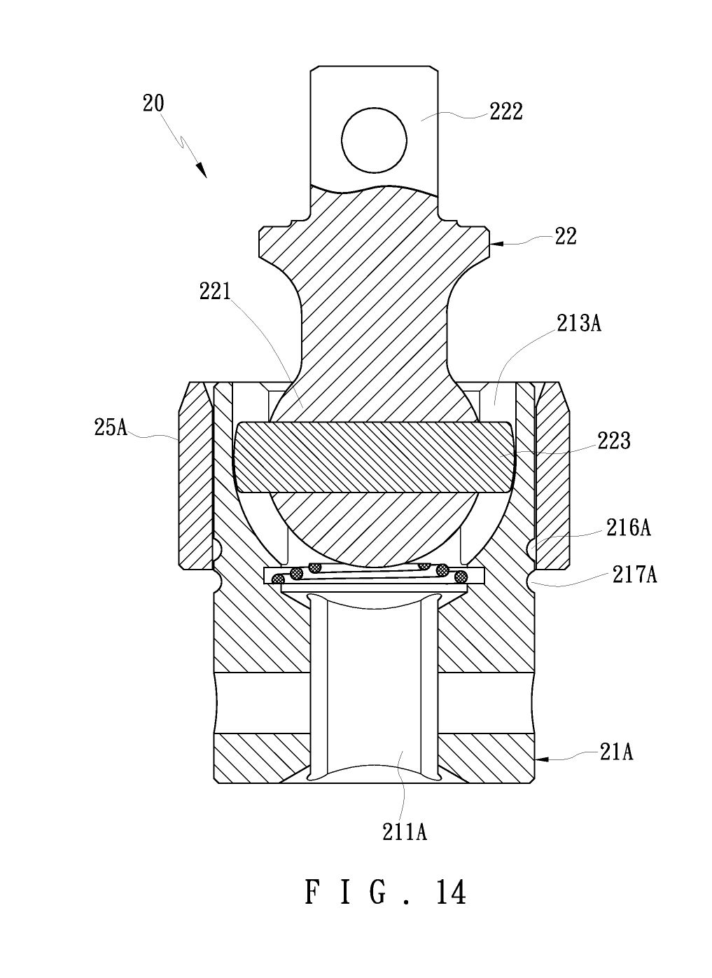

With reference to FIGS. 11-14, a universal joint 20 with a positioning structure according to a second embodiment of the present invention comprises a base 21A and a tool set 22, the base 21A includes a fitting segment 221A disposed on one end thereof and formed in a square hole shape to fit with a driving tool and a receiving groove 212A fixed on another end thereof to receive a spring 23. The tool set 22 includes a knob 221 secured on one end thereof and a driving segment 222 mounted on another end thereof and formed in different types and sizes to fit with an operation tool. Between the receiving groove 212A of the base 21A and the knob 221 of the tool set 22 is defined an engaging structure so that the base 21A actuates the tool set 22 to rotate at the same time. In this embodiment, the engaging structure includes two opposite locking recesses 213A fixed on an inner wall of the receiving groove 212A of base 2A and two opposite retaining blocks 223 fixed on two sides of the circular knob 221 of the tool set 22 respectively so that the knob 221 of the tool set 22 is fixed in the receiving groove 212A of the base 21A, and the two retaining blocks 223 of the tool set 22 retain in the two locking recesses 213A of the base 21A individually so that the base 21A actuates the tool set 22 to rotate simultaneously. The base 21A also includes a fixing structure capable of controlling a replacement of the tool set 22, and the fixing structure includes two holes 214 arranged on a wall of the base 21A and communicating with the receiving groove 212A to receive a pressing member 24 which displaces horizontally and is a rod, and the pressing member 24 extends out of the receiving groove 212A.

The base 21A also includes a sliding sleeve 25A fitted on an outer peripheral surface thereof and displacing upward and downward thereon, the sliding sleeve 25A includes an abutting face 251A formed on an inner surface thereof to push the pressing member 24 to displace inward and a chamber 252 arranged on a top end thereof to receive the pressing member 24 which returns outward, the base 21A also includes at least one connecting segment disposed on the outer peripheral surface thereof, and the least one connecting segment is a locating slot, the sliding sleeve 25A includes at least one coupling segment fixed on the inner surface thereof, and the at least one coupling segment of the sliding sleeve 25A is a fixing element to engage with the locating slot of the base 21A, thus positioning the sliding sleeve 25A. In this embodiment, the base 21A includes a first locating slot 216A and a second locating slot 217A, both of which are secured on the outer peripheral surface of the base 21A, and the sliding sleeve 25A includes an orifice 255A mounted on a wall thereof to receive a ball 27 and a resilient element. In this embodiment, the resilient element is a spring 28, the ball 27 of the sliding sleeve 25A is retained in the second locating slot 217A of the base 21A, and the abutting face 251A pushes the pressing member to move inward so that the knob 221 of the tool set 22 is pressed by the pressing member 24, hence the tool set 22 is fixed on the base 21A, finishing the assembly of the universal joint 20.

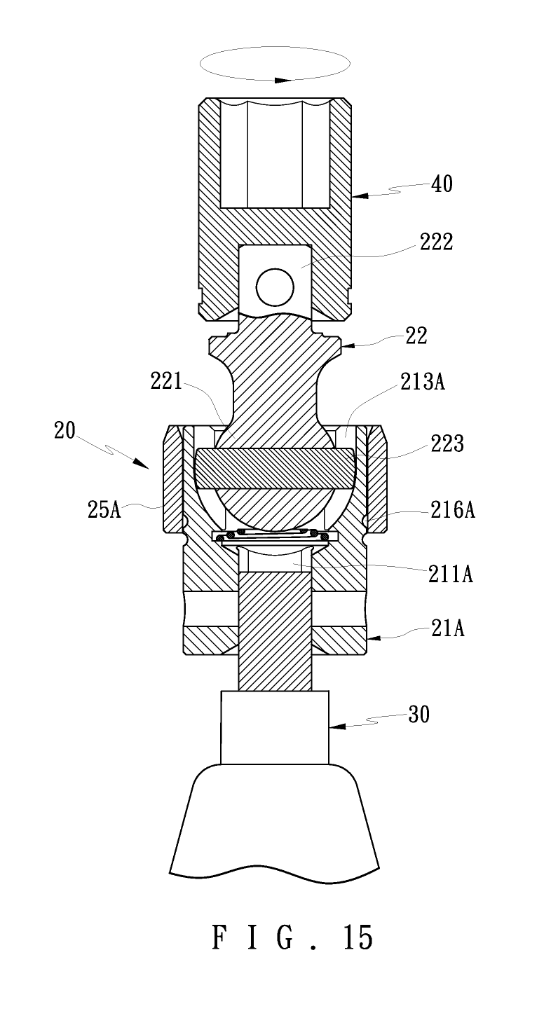

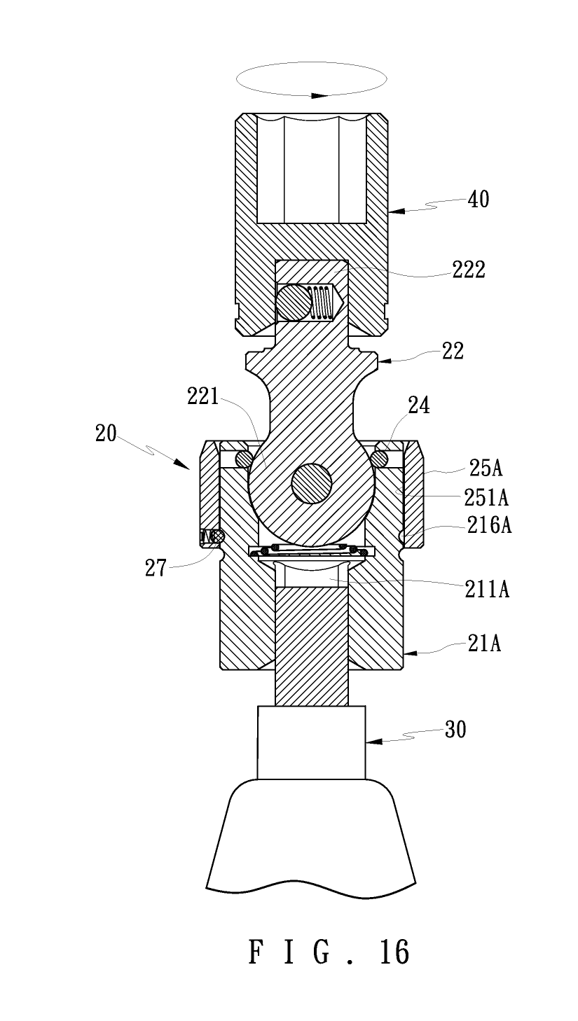

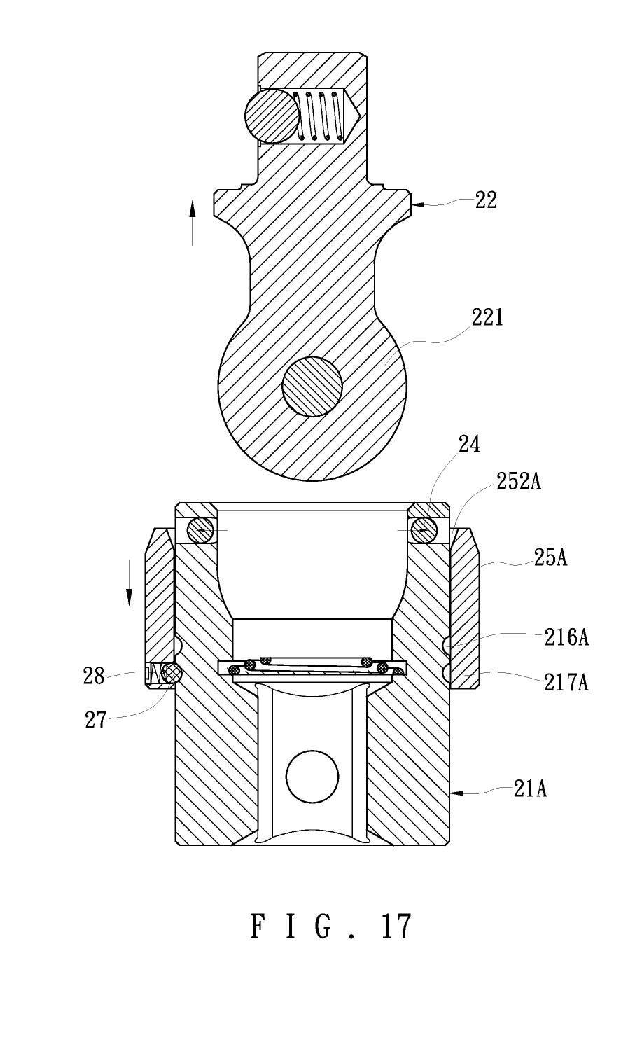

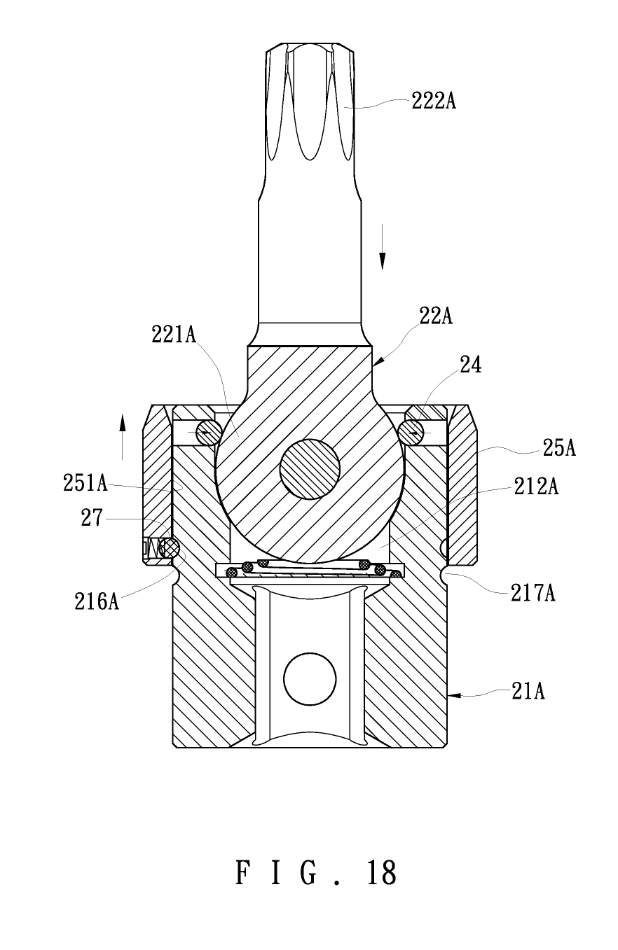

Referring to FIGS. 15 and 16, in operation of the universal joint 20, the fitting segment 211A of the base 21A is fitted with a pneumatic tool 30, and the driving segment 222 of the tool set 22 is fitted with the socket 40. Since the ball 27 of the sliding sleeve 25A engages with the first locating slot 216 of the base 21A so that the sliding sleeve 25A is fixed besides the base 21. Thereby, the abutting face 251A of the sliding sleeve 25A presses the pressing member 24 to abut against the knob 221 of the tool set 22 so that the tool set 22 is fixed on the base 21A securely. When the pneumatic tool 30 actuates the base 21A to rotate, the two locking recesses 213A of the base 21A retain with the two retaining blocks 223 of the tool set 22 individually to actuate the tool set 22 to rotate at the same time, thus obtaining a safe operation. As shown in FIG. 17, when desiring to replace the tool set 22, the sliding sleeve 25A is pushed downward, and the ball 27 is pressed by the outer peripheral surface of the base 21A to move inward so as to further disengage from the first locating slot 216A of the base 21A, and after the ball 27 of the sliding sleeve 25 aligns with the second locating slot 217A of the base 21A, the spring 28 is not pressed by the ball 27 to move outward and to retain in the second locating slot 217A of the base 21A, thereby positioning the sliding sleeve 25. In the meantime, the chamber 252A of the sliding sleeve 25A aligns with the pressing member 24 to provide a space to receive the pressing member 24 which returns to the sliding sleeve 25A. As removing the tool set 22 upward, the knob 221 of the tool set 22 pushes the pressing member 24 to displace outward so that the pressing member 24 moves into the chamber 252A of the sliding sleeve 25A to further disengage from the knob 221 of the tool set 22, thus releasing the positioning of the tool set 22 so that the tool set 22 disengages from the base 21A to have the replacement of tool set. As illustrated in FIG. 18, as positioning another tool set 22A with another driving segment 222A (such as a screwdriver bit), a knob 221A of the tool set 22A is fixed in the receiving groove 212A of the base 21A, and the sliding sleeve 25 is moved upward so that the ball 27 of the sliding sleeve 25A disengages from the second locating slot 217A of the base 21A and is pressed by the outer peripheral surface of the base 21A to displace inward. After the ball 27 is in alignment with the first locating slot 216A of the base 21A, the ball 27 displaces outward and retains in the first locating slot 216A of the base 21A so that the sliding sleeve 25A is positioned outside the base 21A to prevent the sliding sleeve 25A from an upward and downward displacement because of vibration, such that the abutting face 251A of the sliding sleeve 25A pushes the pressing member 24 to abut against the knob 221A of the tool set 22A so that the tool set 22A is fixed on the base 21A securely, thus replacement different tool sets.

While we have shown and described various embodiments in accordance with the present invention, it is clear to those skilled in the art that further embodiments may be made without departing from the scope of the present invention.

What is claimed is:

1. A universal joint with a positioning structure comprising:
a base and a tool seat, the base including a fitting segment disposed on one end thereof and a receiving groove fixed on another end thereof, the tool set including a driving segment formed on one end thereof and a knob mounted on another end thereof and inserted into the receiving groove of the base, and between the receiving groove of the base and the knob of the tool set being defined an engaging structure; wherein the base includes a fixing structure secured thereon, and the fixing structure includes at least one pressing member fixed on a wall of the base and displacing horizontally and a sliding sleeve fitted on an outer peripheral surface of the base, the sliding sleeve includes an abutting face and a chamber to control the at least one pressing member to press the knob of the tool set, and the base also includes at least one connecting segment disposed on the outer peripheral surface thereof, the sliding sleeve includes at least one coupling segment fixed on the inner surface thereof to engage with the at least one connecting segment of the base.

2. The universal joint with the positioning structure as claimed in claim 1, wherein the engaging structure includes a locking portion fixed on the receiving groove of base and a retaining portion fixed on the knob of the tool set to retain with the locking portion of the base.

3. The universal joint with the positioning structure as claimed in claim 2, wherein the locking portion is at least one locking recess fixed on an inner wall of the receiving groove of the base, and the retaining portion is at least one retaining block fixed on a circular knob of the tool set to retain with the at least one locking recess of the base.

4. The universal joint with the positioning structure as claimed in claim 1, wherein the fixing structure includes at least one hole arranged on the wall of the base and communicating with the receiving groove to receive the pressing member which displaces horizontally, wherein the pressing member is selected from a rod and a ball.

5. The universal joint with the positioning structure as claimed in claim 1, wherein the connecting segment of the base is a fixing element to displace resiliently and horizontally, and the coupling segment of the sliding sleeve is a locating slot to engage with the fixing element of the base.

6. The universal joint with the positioning structure as claimed in claim 5, wherein and the fixing element is selected from a C-shaped retainer and a ball, the locating slot is formed by selecting a loop shape or a non-loop shape.

7. The universal joint with the positioning structure as claimed in claim 5, wherein the base includes a trough secured on the outer peripheral surface thereof to receive the C-shaped retainer, and the sliding sleeve includes a first locating slot and a second locating slot, both of which are arranged on the inner surface of the sliding sleeve.

8. The universal joint with the positioning structure as claimed in claim 1, wherein the connecting segment of the base is a locating slot, and the coupling segment of the sliding sleeve is a fixing element to displace resiliently and horizontally and to engage with the locating slot of the base.

9. The universal joint with the positioning structure as claimed in claim 8, wherein the fixing element is selected from a C-shaped retainer and a ball, the locating slot is formed by selecting a loop shape or a non-loop shape.

10. The universal joint with the positioning structure as claimed in claim 8, wherein the base includes a first locating slot and a second locating slot, both of which are arranged on the outer peripheral surface of the base, and the fixing element of the sliding sleeve is a ball, the sliding sleeve includes an orifice mounted on a wall thereof to receive a ball and a resilient element.
